(19) United States
(12) Patent Application Publication
(10) Pub. No.: US 2008/0312990 A1
(43) Pub. Date: Dec. 18, 2008

(54) Knowledge Management System For Asset Managers

(76) Inventor: Roger Alan Byrne, Victoria (AU)

Correspondence Address: LADAS & PARRY LLP, 26 WEST 61ST STREET, NEW YORK, NY, 10023, US

(21) Appl. No.: 11/885,699

(22) PCT Filed: Oct. 11, 2005
(86) PCT No.: PCT/AU2005/001571

§ 371 Date: Mar. 31, 2008

(30) Foreign Application Priority Data
Mar. 8, 2005 (AU) 2005901099

(51) Int. Cl. G06Q 10/00

(52) U.S. Cl. 705/7

(57) ABSTRACT

A knowledge management system is provided to assist asset owners, managers and operators in the management of assets. The knowledge management system includes a database for storing a plurality of manuals, each manual including world's best practice guidelines with regard to an aspect of an asset life cycle; a performance analysis tool for benchmarking an organisation's performance with regard to each aspect of the asset life cycle to identify areas for improvement; and, a benefit assessment component to assist the organisation in determining which improvements have potential to deliver the greatest benefits. The knowledge management system enables the best practice guidelines to be tailored to suit particular organisations and/or asset types.

### FIELD OF THE INVENTION

The present invention relates generally to systems which facilitate capturing, organising, storing and disseminating knowledge and more particularly to systems for management of knowledge pertaining to life cycle asset management.

### BACKGROUND TO THE INVENTION

Asset management is a systematic approach to the procurement, maintenance, operation, rehabilitation and disposal of assets. It considers asset utilization and performance with respect to the requirements of asset owners and/or users. Asset management involves continuous evaluation of asset performance to ensure that the required service delivery outputs are being met and will continue to be met into the future.

Asset management involves the application of best management practices to an entire portfolio of infrastructure assets by organisations which are seeking to minimize the costs involved in acquiring, operating, maintaining and renewing their assets, whilst delivering the required service levels.

Most known computerised asset management information systems are either directed to maintaining an inventory of assets or focus on managing a particular aspect of the asset life cycle such as operation and maintenance. Known asset management systems do not provide structured guidelines for strategic planning, investment in, operation and maintenance of and disposal of assets.

Strategic planning for asset management involves forecasting the expected growth (or decline) in demand for an organisation's products and/or services in order to estimate the need to purchase physical plant, equipment and similar assets which are required to achieve the forecasted demand. In addition to forecasting expenditure on acquisition of plant and equipment, an organisation also needs to be able to forecast expenditure on operation, maintenance and rehabilitation of existing assets. Asset management strategic planning is intended to enable organisations to minimize unplanned resource-driven activities (i.e. corrective maintenance), and to maximize planned activities (i.e. preventative maintenance).

Investment in public infrastructure has played a significant role in the sustained wealth, prosperity, and quality of life of industrialised countries. However, much of this infrastructure is rapidly deteriorating from over-use, old age and inadequate maintenance, repair, rehabilitation, and replacement. Whilst agencies responsible for the management of public infrastructure assets continue to invest in asset improvements, the rate of investment does not even begin to match the rate of deterioration of existing infrastructure assets or adequately fund the infrastructure needs of the future.

A large proportion of an organisation's expenditure relates directly to the assets that deliver the services provided by the organisation, this expenditure needs to be managed as efficiently and effectively as possible. This is achieved by conforming to “best practice” standards to ensure that customers and stakeholders are receiving the required and desired level of service, at the lowest sustainable life cycle cost or “best value”.

There is a need for a process that allows organisations to clearly identify how they currently rate against similar agencies and organisations and how that rating compares to what is the “best appropriate practice” for their organisation and their assets at a particular point in time.

The discussion of the background to the invention included herein is included to explain the context of the invention. This is not to be taken as an admission that any of the material referred to is published, known or part of the common general knowledge as at the priority date of the claims.

### SUMMARY OF THE INVENTION

According to an aspect of the present invention, there is provided a knowledge management system for assisting asset owners, managers and operators in managing assets, the system including:

a database for storing a plurality of manuals, each manual including best practice guidelines with regard to an aspect of an asset life cycle;

a performance analysis tool for benchmarking an organisation's performance with regard to each aspect of the asset life cycle to identify areas for improvement; and

a benefit assessment component to assist the organisation in determining which improvements have potential to deliver the greatest benefits;

wherein the knowledge management system enables the best practice guidelines to be tailored to suit particular organisations and/or asset types.

Preferably, the performance analysis tool benchmarks the organisation's performance with regard to each aspect of the asset life cycle against one or more of the following: world's best practice; practice of a set of similar organisations; or, best appropriate practice for the organisation concerned.

In accordance with a preferred embodiment of the invention, the system further includes:

a goal setting component to enable the organisation to define one or more goals in accordance with the benefit assessment, the goals forming the basis of an asset management strategic plan; and

a monitoring tool for monitoring the organisation's progress along the asset management strategic plan.

The system may further include a reporting component for generating one or more reports which demonstrate improvements achieved relative to the goals set by the organisation.

In a preferred form of the present invention, the system is available to asset managers and operators over a telecommunications network. Preferably, the telecommunications network is the Internet. Most preferably, the knowledge management system and manuals are web-enabled.

According to another aspect of the present invention, there is provided a method for capturing, organising, storing and disseminating knowledge to assist asset owners, managers and operators in managing assets, the method including the following steps:

storing a plurality of manuals in a database, each manual including best practice guidelines with regard to an aspect of an asset life cycle;

benchmarking an organisation's performance with regard to each aspect of the asset life cycle to identify areas for improvement; and

assessing which improvements have potential to deliver the greatest benefits to the organisation;

wherein the method enables the best practice guidelines to be tailored to each particular organisation and/or asset type.

Preferably, the organisation's performance with regard to each aspect of the asset life cycle is benchmarked against one or more of the following: world's best practice; practice of a set of similar organisations; or, best appropriate practice for the organisation concerned.

In a preferred embodiment of the invention, the method further includes the following steps:

defining one or more goals in accordance with the benefit assessment, the goals forming the basis of an asset management strategic plan; and

monitoring the organisation's progress along the asset management strategic plan.

The method may further include the step of generating one or more reports which demonstrate improvements achieved relative to the goals set by the organisation.

According to yet another aspect of the present invention, there is provided a method for capturing, organising, storing and disseminating knowledge to assist asset owners, managers and operators in managing assets, the method including the following steps:

storing a plurality of manuals in a database, each manual including best practice guidelines with regard to an aspect of an asset life cycle;

benchmarking an organisation's performance with regard to each aspect of the asset life cycle to identify areas for improvement; and

assessing which improvements have potential to deliver the greatest benefits to the organisation;

determining a confidence level rating based on the quality of data used to benchmark the organisation's performance;

providing a logical structure for the organisations to manage their assets through all aspects of the asset life cycle;

defining one or more goals in accordance with the benefit assessment, the goals forming the basis of an asset management strategic plan;

providing implementation guidelines to assist the organisation in achieving the goals; and

monitoring the organisation's progress along the asset management strategic plan.

An advantage of the present invention is that it facilitates the development of long term strategy plans for asset replacement and/or rehabilitation.

Another advantage of the present invention is that the identification and implementation of appropriate asset management development strategies results in higher returns on investment, improved maintenance practices, lower life cycle costs, increased awareness of risks and liabilities and more competitive operating strategies.

### BRIEF DESCRIPTION OF THE DRAWINGS

The invention will now be described in further detail by reference to the attached drawings illustrating example forms of the invention. It is to be understood that the particularity of the drawings does not supersede the generality of the preceding description of the invention. In the drawings:

FIG. 1 is a schematic diagram of the life cycle of an asset.

FIG. 2 is a schematic diagram of the asset management quality framework.

FIG. 3 is a schematic diagram showing the key elements of the asset management quality framework.

FIG. 4 is a schematic view of a step-by-step process by which an organisation can improve its performance rating.

FIG. 5 show how the quality GAP is determined.

FIG. 6 is a screen view showing how the system can be navigated via a main menu according to an embodiment of the present invention.

FIG. 7 is the screen view of FIG. 6 with the main menu expanded to reveal further content.

FIG. 8 is the screen view showing how the guidelines relating to the asset life cycle can be navigated via an asset life cycle diagram.

FIG. 9 shows a guideline document open for viewing.

FIG. 10 shows a glossary which is accessible via the main menu.

FIG. 11 is a schematic overview of the knowledge management system according to one embodiment of the invention.

### DETAILED DESCRIPTION

To improve the efficiency and efficacy of its asset management practices, an organisation needs to determine a vision for future sustainable infrastructure portfolio service delivery practices in line with the organisation's overall goals and objectives, and to determine how the required improvements should be identified and how the necessary programs should be implemented to ensure that this vision is realised. This vision development and analysis is enabled by the knowledge management system provided by the present invention.

The present invention provides a knowledge management system, which facilitates the efficient management of assets by asset owners, managers and operators. The system includes a database for storing a number of manuals covering best practice guidelines with regard to the various aspects of a life cycle of an asset. The system further includes a performance analysis tool which enables organisations to benchmark their own performance with respect to each aspect or stage of the asset life cycle. This enables organisations to clearly identify those areas in which there is room for improvement. A benefit assessment component assists the organisation which has undergone the benchmarking exercise to determine which improvements have potential to deliver the greatest benefits to the organisation. Thereby, the best practice guidelines can be tailored to each particular organisation and/or to each asset type managed by a particular organisation. The knowledge management system of the present invention is accessible to asset owners, managers and operators via a telecommunications network such as the Internet.

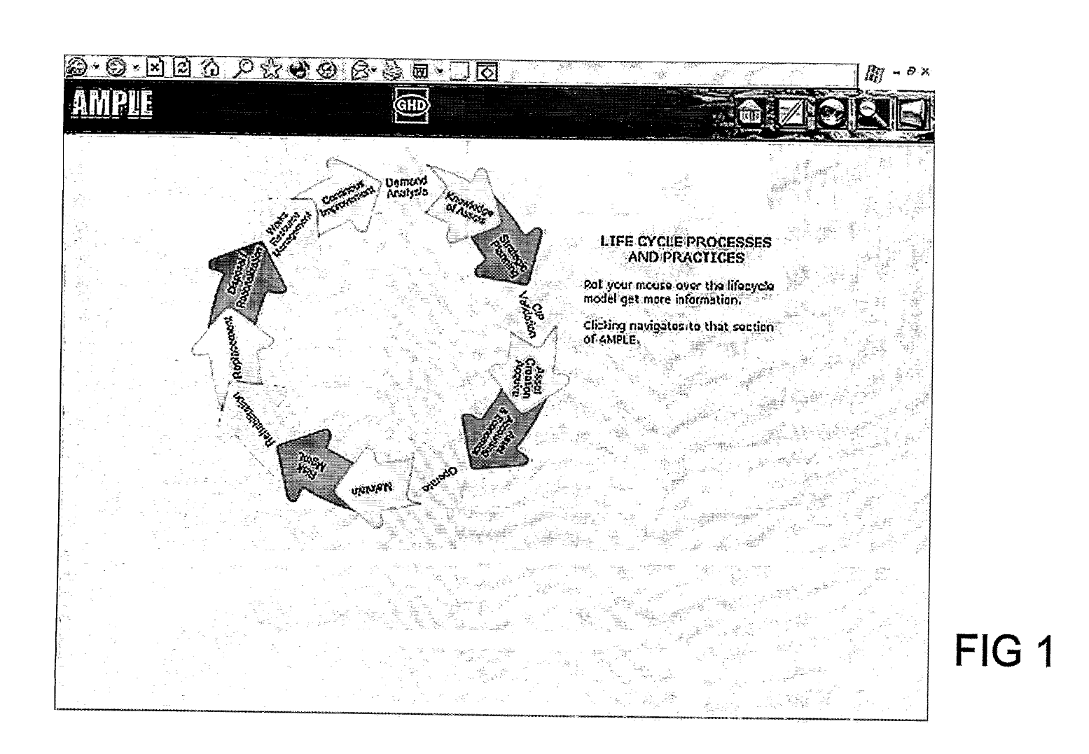

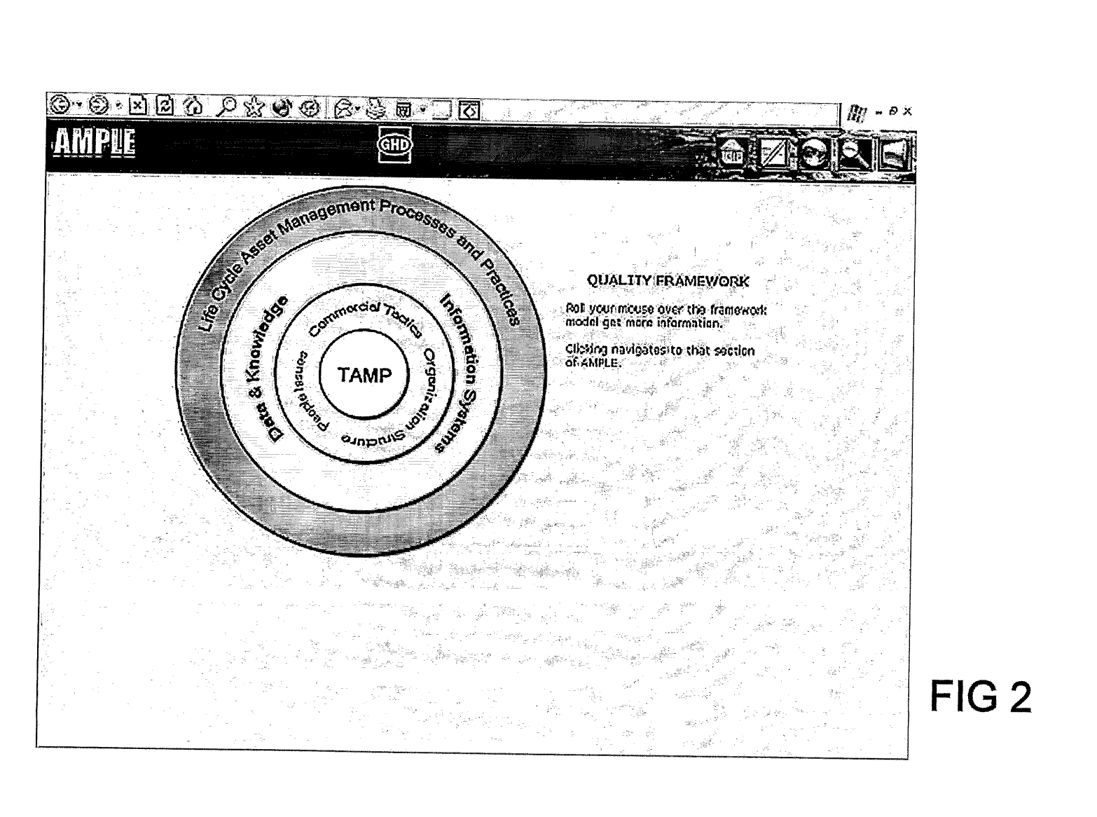

Referring now to FIG. 1, the life cycle of an asset can be broadly broken down into the following stages: strategic planning, investment, operation and maintenance, and disposal. Strategic planning involves a determination as to the demands and service levels which an asset is required to meet and the development of a strategic plan for the management of all decision making processes that will need to be undertaken throughout the intended life cycle of a physical asset. Maintenance includes corrective maintenance which is undertaken after a failure of an asset to perform its required function, or preventative or predictive maintenance which is carried out at regular predetermined intervals in an effort to reduce the likelihood that a failure or degradation in performance of the asset will occur. In practice the life cycle functions are a subset of the total enterprise asset management quality framework (TEAMQF) as shown in FIG. 2.

Referring now to FIG. 2, organisations adopt the quality framework to ensure that consistent, repeatable performance assessments are made in relation to the asset life cycle, to enable the identification of cost effective improvements. The organisation's performance is rated against one or more elements of the total enterprise asset management quality framework (TEAMQF). The performance rating is used to determine a confidence level rating which is used to establish a “best appropriate practice” for that organisation.

Use of the total enterprise asset management quality framework (TEAMQF) enables the organisation to be rated for comparison against similar organisations and businesses and ensures that the rating is repeatable over time to enable progress to be monitored. Adoption and effective implementation of the quality framework enables the organisation to comply with ISO quality standards pertaining to life cycle asset management, thereby enabling the organisation to acquire ISO accreditation using prescribed assessors.

The best practice guidelines provided in the manuals stored in the database associated with the knowledge management system, define “world's best practice” with respect to particular stages of the asset life cycle. Access to these worlds's best practice guidelines enable asset managers and operators to make informed decisions based on an awareness of the recognised world's best practice with respect to asset management. The world's best practice guidelines provide a dynamic reference system that is continually updated as a result of research conducted by national and international agencies and professional organisations.

The best practice guidelines are tailored to various asset types. What constitutes best appropriate practice in relation to one particular asset type will not necessarily be relevant to all other asset types. It is intended that the knowledge management tool will address all infrastructure and physical asset types involved in service delivery including the following:
Water supply;
Waste water;
Electricity utilities;
Gas utlities;
Drainage/stormwater;
Flood mitigation and rivers;
Irrigation systems;
Roads/pavements and footpaths;
Bridges & tunnels;
Road furniture & traffic controls;
Transport-buses;
Railways;
Ports & Harbours;
Airports;
Buildings;
Sports and recreation;
Parks and gardens;
Mobile plant & equipment;
Mines;
Health facilities & equipment;
Education facilities;
Justice and corrections;
Museums and art centres;
Manufacturing facilities;
Food processing facilities;
Oil and gas facilities; and
Other similar infastructure rich businesses.

Best appropriate practice relates to the way in which organisations and their employees conduct their business activities in all key processes including leadership, planning, customer and supplier relations, community relations, production and supply of products and services, and benchmarking. Effective integration of best appropriate practice into an organisation's asset management practices leads towards sustainable outcomes in quality and customer service, flexibility, timeliness, innovation, cost and competitiveness at a world's best practice level.

In theory, if an organisation applied world's best practice in every instance, using only accurate data, this would lead to the correct decision being made in every instance resulting to a 100% confidence level rating in the outcomes. However, world's best practice is not necessarily appropriate for all organisations responsible for the management of infrastructure. Different organisations need to determine what is required and appropriate to deliver the outcomes and confidence level rating desirable in their own circumstances. In some cases organisations may need to determine different best appropriate practices for the various asset types that they manage. A combination of the technical and financial considerations over the entire life cycle of an asset will lead to best appropriate practice asset management for a particular life cycle process and practice for a particular asset in a particular organisation. Every asset is different and every organisation faces different issues and so the solution needs to be tailored to these circumstances rather than simply adopting a generic world's best practice. The system of the present invention addresses this need by enabling each agency to clearly identify what is best appropriate practice for their agency and their assets at a particular point in time.

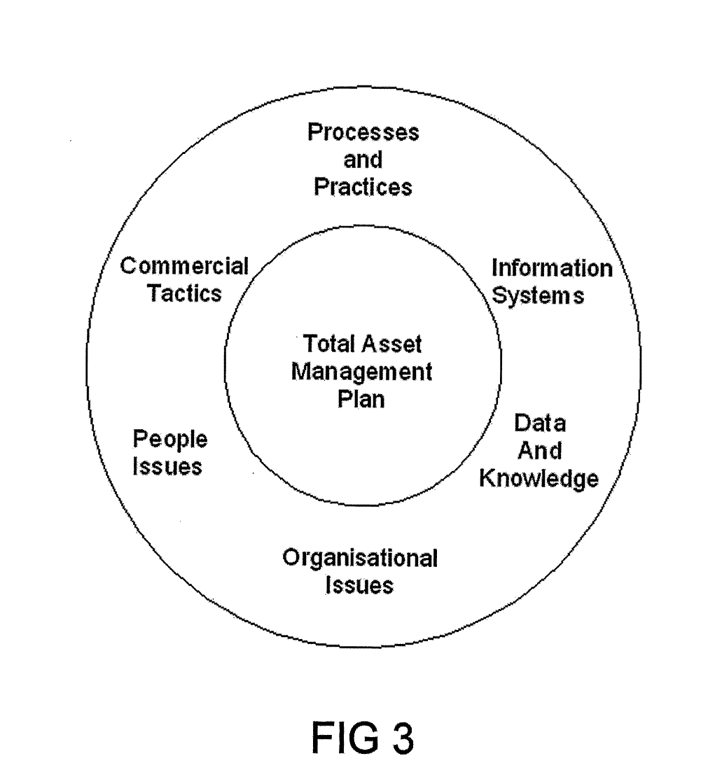

The total enterprise asset management quality framework (TEAMQF) was developed to meet the organisational requirements of “best appropriate practice”. Referring now to FIG. 3, the quality framework follows an established business “value chain” process using key quality processes based on seven primary elements of life cycle asset management namely:

1. Processes and Practices cover the whole life cycle of an asset;

2. Information Systems support the asset management processes;

3. Asset Data and Knowledge which includes organisational policies for the acquisition and maintenance of knowledge;

4. Organisational Issues include the manner in which the organizational structure supports life cycle asset management functions;

5. People Issues include human resource issues associated with best practice asset management;

6. Commercial Tactics relate to tactical processes used by the organisation to complete tasks identified by their “best appropriate practice” processes including packaging and contestability to contract out services; and finally,

7. Total Asset Management Plans that draw together all of the above elements to produce the strategic direction and plans for maintaining sustainable development of the organisations asset portfolios for present and future generations.

This performance analysis structure has proved highly effective when applied using a step-by-step approach to identifying and implementing the world's best practices and techniques are appropriate to a given organization, thereby assisting in outlining an implementation strategy for a given organization. Effective implementation programs are based on tasks which are prioritized to match organizational strategies and goals.

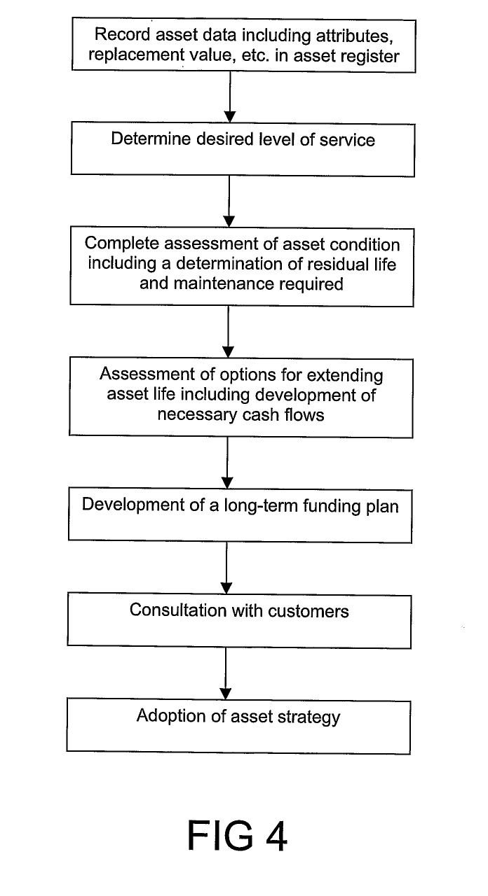

FIG. 4 shows how an organisation can take steps to improve its performance rating from innocence (i.e. no knowledge of world's best practices) to having implemented world's best practices by following a step-by-step process.

Asset management is built around a modest number of core “building block” techniques or “practices and processes”. These core techniques include asset hierarchies and data standards, levels of service, condition and residual life assessment, valuation and life cycle costing, risk-consequence determination, optimal renewal decision-making, business risk exposure, confidence level metrics, and “whole portfolio” financial planning. Each of these techniques and their related practices can be deployed at different levels of sophistication. The system presents a ‘step by step’ approach to the delivery of asset management improvements in each of the quality elements.

Each organisation needs to determine what steps are required to provide the improvements and undertake only those that are warranted or can be justified in an economic sense by using the benefit assessment component of the system. The benefit assessment component provides a link between the benefits achieved by other similar organisations in closing the gap from current practice to best practice, and those organisations endeavouring to undertake to close the gap. The benefit assessment component is based on the benefit assessments of previous users of the tool. These processes are further broken down into 23 secondary elements and 163 tertiary elements. A complete list of the current total enterprise asset management quality framework (TEAMQF) elements is attached as Appendix I. This list is dynamic and may be amended from time to time as new processes and practices are identified. The tool will be enhanced by the addition of proven practices into the total enterprise asset management quality framework complete with the relevant quality elements and their interdependence with existing elements.

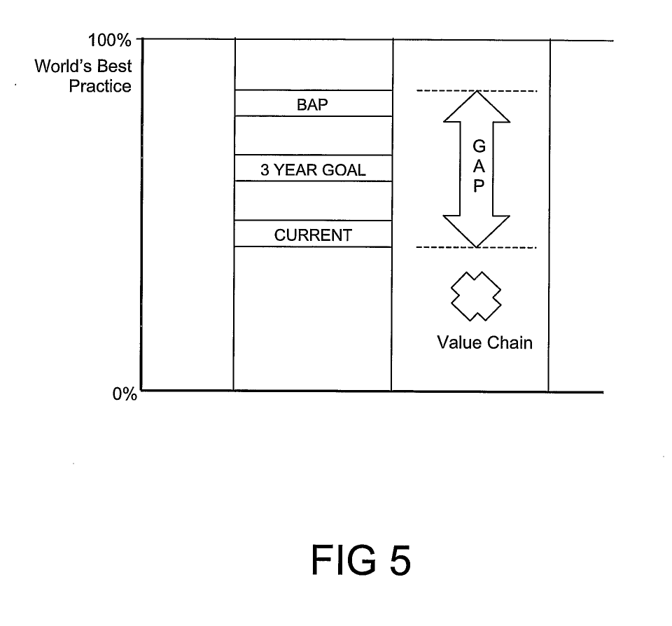

By measuring the performance achieved against the quality elements the organization can determine the quality “gap” that exists between the existing practices and the steps required to achieve best appropriate practice. FIG. 5 shows how this quality gap can be measured and prioritised by use of a value chain corresponding to the individual organisation or user. The organisation's “value chain” is based on a value that an improvement will add to a quality rating and overall confidence level rating for the organisation, and the cost benefit that this represents to the organisation. The benefits achieved by other organisations in improving their asset management best appropriate practice can be used to demonstrate to an organisations who's asset management performance is currently being assessed, what gains and benefits can be achieved.

The performance analysis tool uses an online analysis process, which enables organisations to assess their performance with respect to each aspect or stage of the asset life cycle, by comparison to the world's best practice and to other organisations and businesses operating in the same or similar industry sectors. The tool uses a total enterprise asset management quality framework (TEAMQF) to enable a normalised rating of performance to be determined which not only rates the organisation and benchmarks the organisation against similar businesses, but is also repeatable to enable the organisations progress to be monitored over time.

The knowledge management system of the present invention takes the form of an intuitive and user-friendly set of on-line process and practice guidelines, and other decision support tools that simplify the development of consistent asset management strategic plans, provide effective implementation guidelines for performance assessment, and guidelines for the delivery of meaningful improvements.

The web enabled best practice manuals need to be easy to navigate so that a user can quickly locate the information that they are looking for. This is achieved by providing a number of ways in which the user can access and navigate the manuals. The manuals are classified by reference to the stage of the asset life cycle to which they relate. When a button on the main menu is clicked further links to content are revealed.

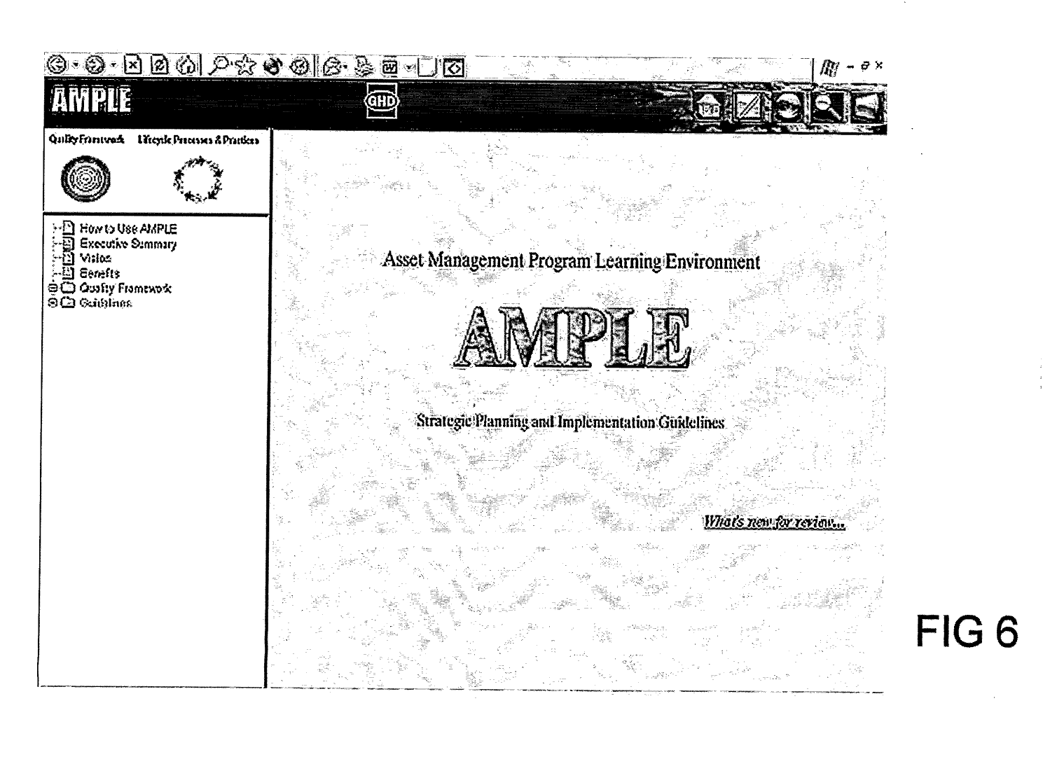

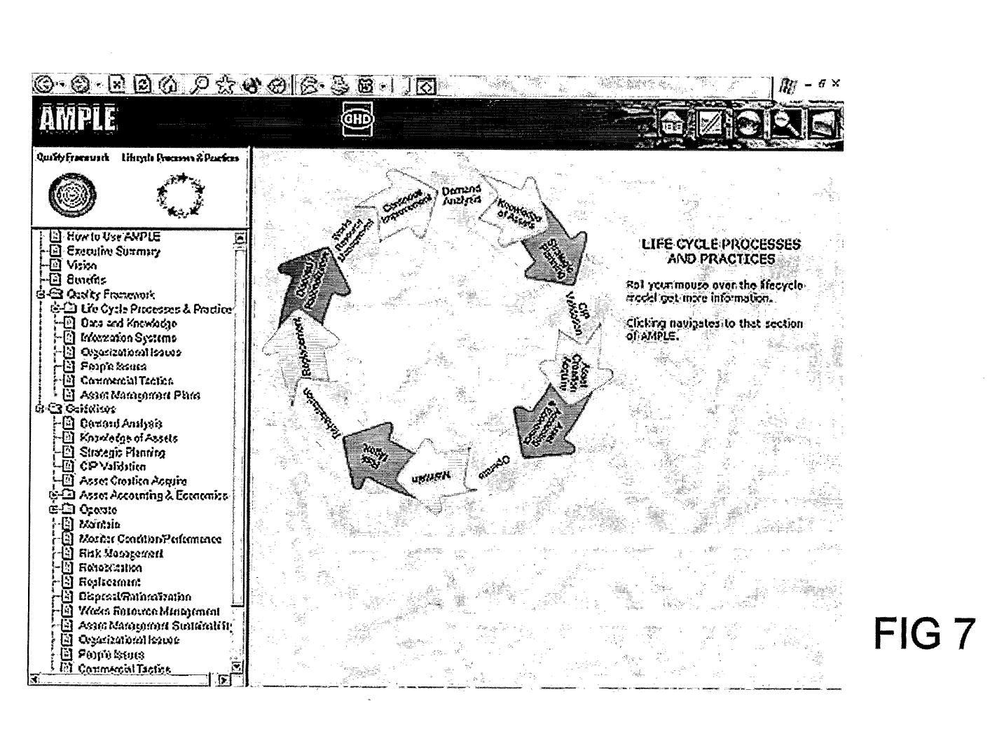

Referring now to FIG. 6, above the expanding tree explorer structure are the two wheels of the Quality Framework and the Asset Lifecycle Processes and Practices. These wheels represent the main knowledge bases into which the information is stored in the knowledge management system which, expands on the main screen and is linked to the tree structure. The manuals can be navigated by clicking on one of the two wheels. In FIG. 7, the Asset Life Cycle Processes and Practices diagram is displayed in the large viewing window on the right hand side of the screen. By moving the cursor over the diagram and clicking on the element of interest, it is possible to navigate to the information relating to that stage of the asset life cycle.

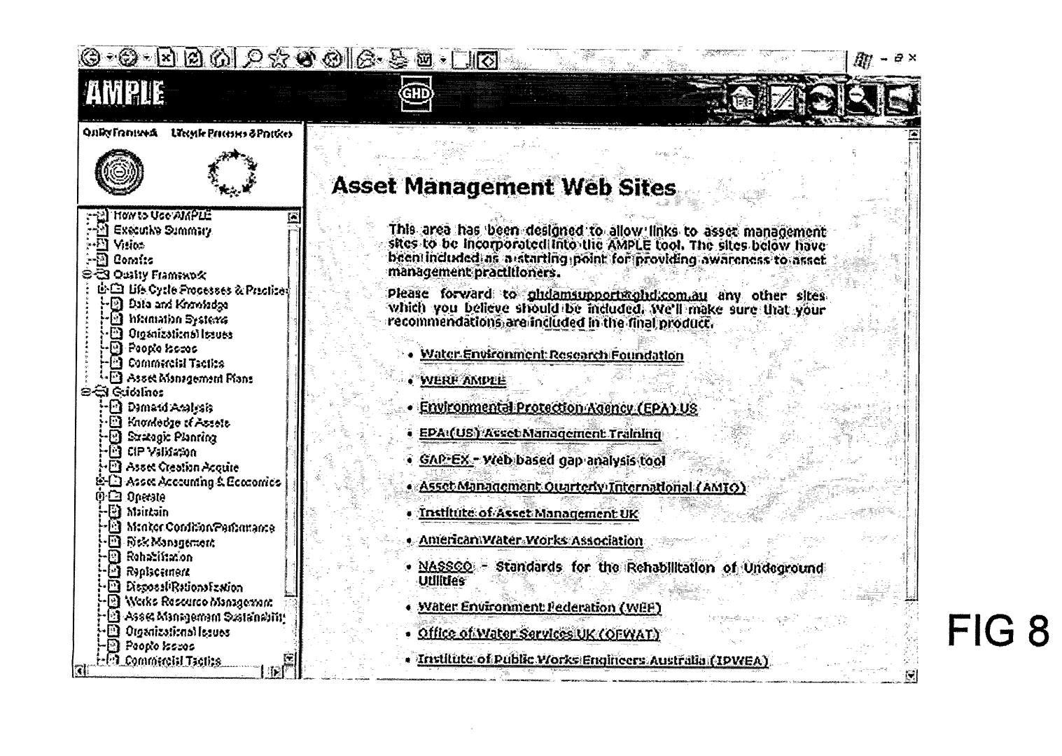

Alternatively, the manuals can be navigated via an expanding tree explorer structure located in the bottom left hand corner of the screen. This functions in much the same way as the expanding tree explorer structure in MicroSoft® Windows Explorer. The expanded tree explorer structure is shown in FIG. 7. Clicking on one of the branches opens the document in the large viewing window as shown in FIG. 8.

A user of the tool wanting to find specific references that relate to individual asset types will be able to do this by referring to the asset types involved in the services. For instance, waste water services, a user would refer to practice manuals relating to vitrified clay sewers.

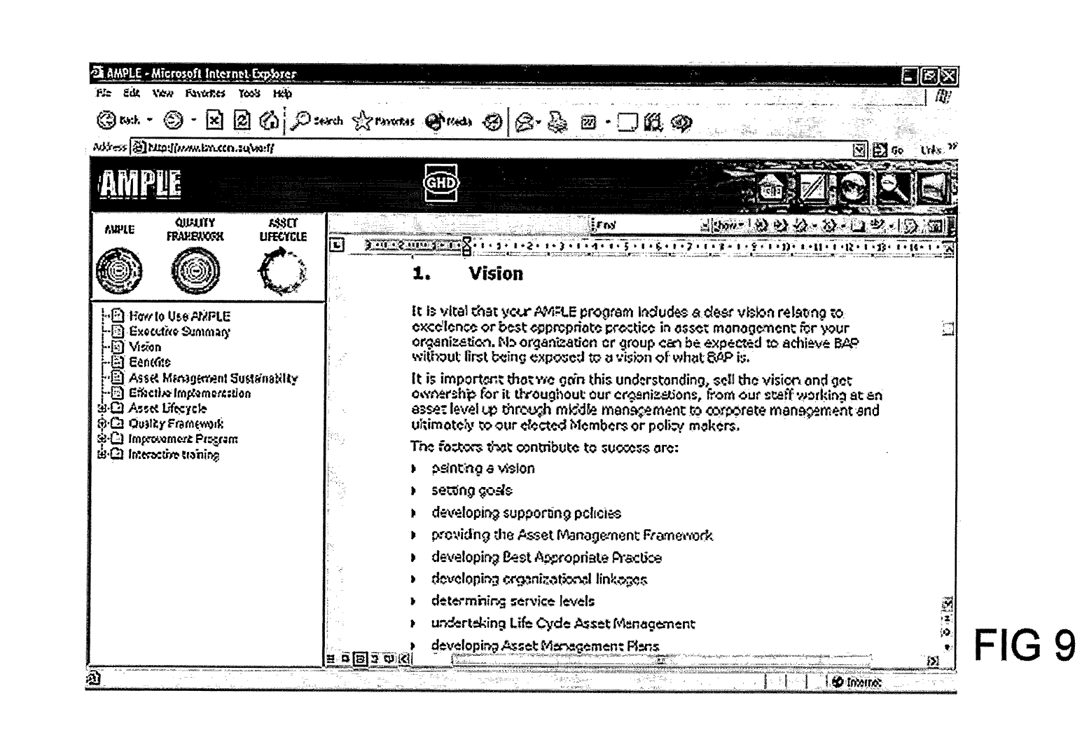

Referring now to FIG. 9, this screen view shows how a manual document is opened for viewing. The user can toggle between a full screen view by clicking on the toggle icon top right corner of the screen, where the active area is expanded to the full width of the window (i.e. the table of contents is hidden from view), then back to the view shown in FIG. 8 which enables ready access to the table of contents whilst viewing the document.

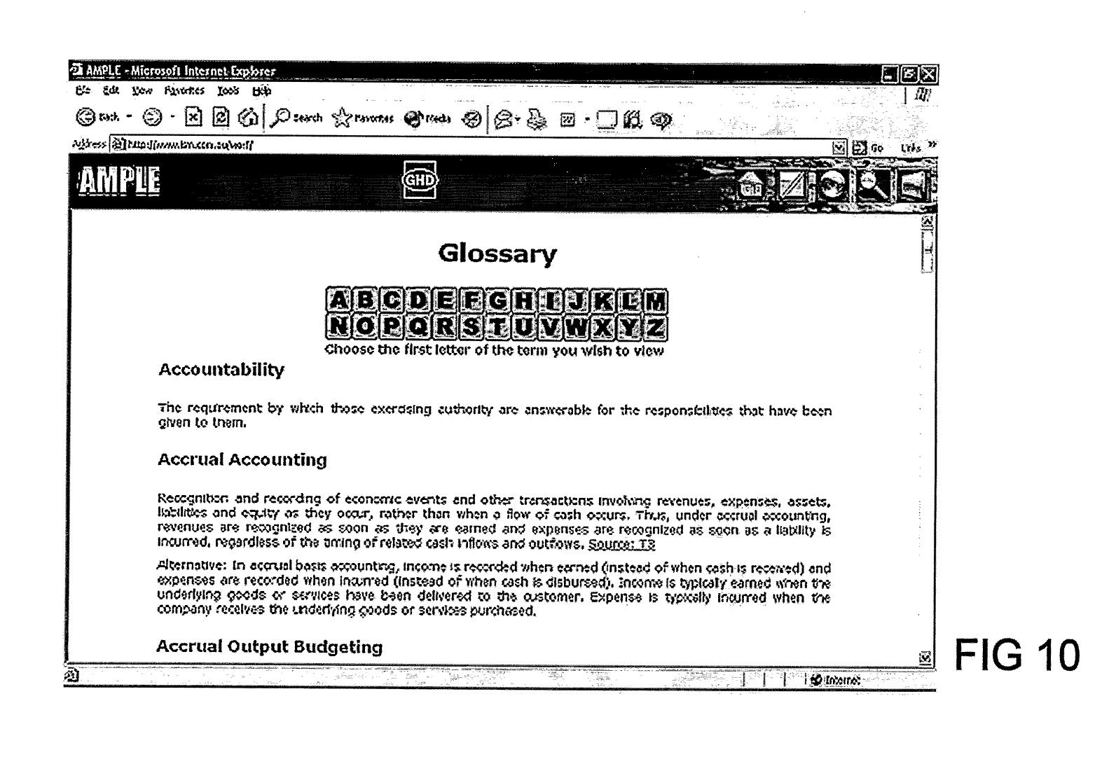

Referring now to FIG. 10, the screen view shows the glossary of terms which can be accessed using the buttons on the upper right hand side of the screen. In this view, the active window has been expanded to the full width of the window.

The system includes an asset management program learning environment (AMPLE) wherein asset managers and owners can be educated as to how to improve their asset management practices and as to how the knowledge management system of the present invention is best utilised to achieve maximum benefits for the organisation. This provides hands on learning or structured training and skills transfer tool which facilitates the cultural changes necessary within an organisation for improvements in their asset management practices to occur.

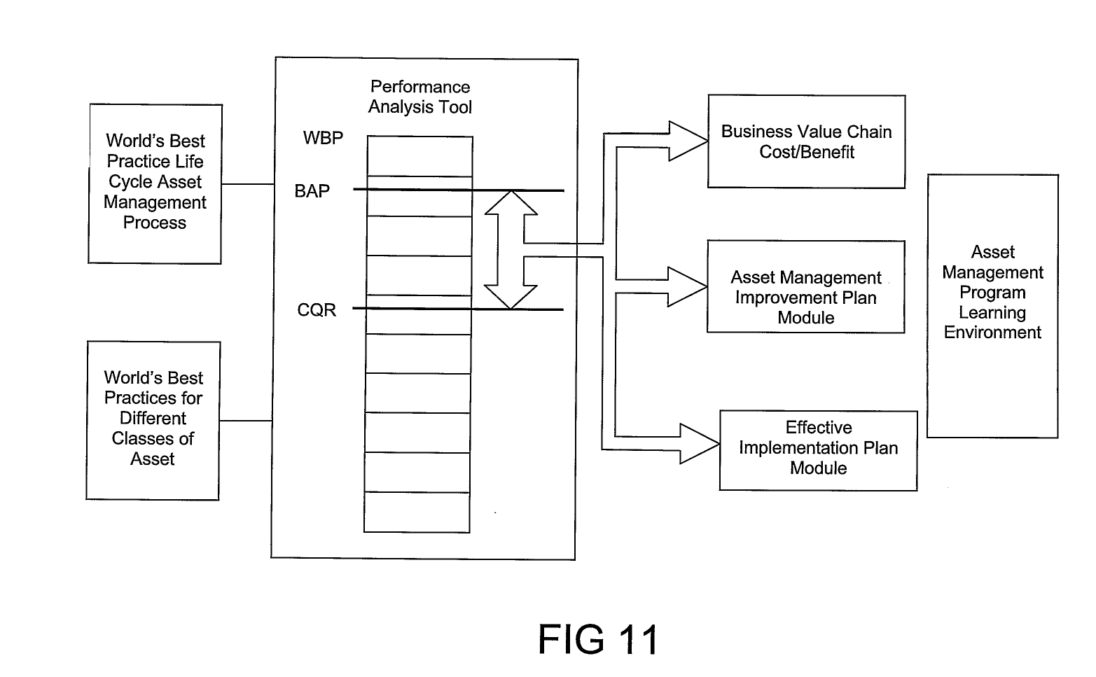

Referring now to FIG. 11, there is shown a schematic overview of the interrelationship between the various system components as described in more detail above.

Effective asset management requires the consideration of the entire asset life cycle process from the initial concept or identification of a demand for a product or service through to the creation or acquisition of the relevant asset, its operation, maintenance and renewal and through to disposal. Whilst this may be considered to be relatively easy when considering a single asset, it becomes extremely complex when an organisation owns a mature infrastructure network or portfolio consisting of hundreds of thousands of individual assets.

Strategic asset management plans enable organisations to predict the future costs and performance of an asset portfolio providing that the suggested guidelines are followed. Such plans assist in identification and implementation of appropriate asset management development strategies resulting in higher returns on investment, improved maintenance practices, lower life cycle costs, awareness of risk and liability and competitive operating strategies. The knowledge management system of the present invention provides organisations responsible for the management of infrastructure assets with a quality framework of high-level strategic asset management information that can support business planning through the asset lifecycle process in the most cost effective manner.

It is to be understood that various additions, alterations and/or modifications may be made to the parts previously described without departing from the ambit of the invention.

### APPENDIX I

### 1.00 Processes And Practices Of The Asset Portfolio Life Cycle

1.01 Demand Analysis
   1.01.1 Historic Records
   1.01.2 Element Break Up
   1.01.3 Customer and Stakeholder Surveys
   1.01.4 Levels of Service/Contracts
   1.01.5 Trend Predictions
1.02 Knowledge of Assets
   1.02.1 Hierarchical Level Structure
   1.02.2 Physical Attributes and Data Standards
   1.02.3 Condition Data Standards
   1.02.4 Performance Data Standards
   1.02.5 Utilisation Data Standards
1.03 Asset Accounting and Cost/Costing
   1.03.1 Valuations
   1.03.2 Depreciation and Effective Lives
   1.03.3 Operational Costs
   1.03.4 Maintenance Costs
   1.03.5 Renewal Liabilities
   1.03.6 Residual Risk Assessment
   1.03.7 Historical Cost Data
1.04 Strategic Planning (Life Cycle)
   1.04.1 Failure Mode Prediction—growth & renewal
   1.04.2 Risk Assessments
   1.04.3 Optimised Renewal Decision making
   1.04.4 Life Cycle Cost Analysis
   1.04.5 Improvements/Efficiency Programs
   1.04.6 Total Asset Management Plan production
   1.04.7 Customer Review and Consultation
   1.04.8 Linking to business goals
   1.04.9 Budget Rationalisation Process.
1.05 Capital Expenditure Evaluation and Approval Process
   1.05.01 Corporate Policy/Guidelines
   1.05.02 Cause of Expenditure
   1.05.03 Risk Based/Stepped Evaluation Process
   1.05.04 Demand Analysis/income Projections
   1.05.05 Supply/Program Options
   1.05.06 Operations and Maintenance
   1.05.07 Multiple Solution Options
   1.05.08 Economic Evaluation Process
1.06 Business Risk Assessment and Management
   1.06.01 Risk Policy
   1.06.02 Risk Identification
   1.06.03 Risk Quantification
   1.06.04 Risk Analysis
   1.06.05 Risk Reduction Management Program
1.07 Asset Creation & Acquisition Process
   1.07.01 Project Identification/Program Management
   1.07.02 Contract Administration
   1.07.03 Project Management
   1.07.04 Design/Value Engineering
   1.07.05 Maintainability/Operability
   1.07.06 Construction Standards and Quality Control
   1.07.07 Asset Commissioning and Handover
1.08 Asset Rationalisation & Disposal
   1.08.01 Asset Rationalisation
   1.08.01 Asset Disposal
1.09 Asset Operations
   1.09.01 Operating Procedures
   1.09.02 Operating Manuals
   1.09.03 Complaints System
   1.09.04 Emergency Response Plans
   1.09.05 Performance Monitoring and Control
   1.09.06 Automated Control (SCADA) Systems
1.10 Asset Maintenance
   1.10.01 Policy
   1.10.02 Planning
   1.10.03 Scheduling
   1.10.04 Job Execution and Control/Feedback
   1.10.05 Maintenance Costing
   1.10.06 Maintenance Manuals/Instructions
   1.10.07 Review/Analysis Processes
   1.10.08 Strategy
1.11 Work/Resource Management
   1.11.01 Resource Allocation
   1.11.02 Resource Prioritisation
   1.11.03 Job Project Management
   1.11.04 Inventory/Stock Control
   1.11.05 Predictive Resource Planning
1.12 Review Audit (Continuous Improvement Processes)
   1.12.01 Asset Management Quality Manuals/Guidelines
   1.12.02 Asset Management Process Diagrams
   1.12.03 Internal QA Practices
   1.12.04 Independent Asset Management Audit and Benchmarking
   1.12.05 Identification of Cost Reduction Opportunities
   1.12.06 Improvement Program Implementation (Effectiveness)

2.00 Asset Information (Support) Systems
2.01 Primary Applications
   2.01.01 Finance System
   2.01.02 Customer and Property Records
   2.01.03 Complaint Customer Management Relationship System
   2.01.04 Asset Register
   2.01.05 Plans and Drawing Records
   2.01.06 Geographic Information Systems
   2.01.07 Maintenance Management System
   2.01.08 Operations & Maintenance Manuals
   2.01.09 Works Management (Job/Resource) System
   2.01.10 SCADA —Automated system control and data acquisition
2.02 Secondary Applications
   2.02.01 Knowledge Management/EDC System
   2.02.02 Inventory/Spares and Purchasing System
   2.02.03 Condition Assessment and Record System
   2.02.04 Capacity/Utilisation Predictive Models
   2.02.05 Predictive Models for Other Primary Failure Modes
   2.02.06 Emergency Response Plans
   2.02.07 Contract Management/Administration System
2.03 Tertiary (Life Cycle) Applications
   2.03.01 Risk Assessment (Consequence of Failure)
   2.03.02 Treatment or Risk Reduction Cost Options
   2.03.03 Optimised Renewal Decision Making (ORDM)/Capital Investment Evaluation
   2.03.04 Life Cycle Cost System
   2.03.05 Mobile Computing Systems
   2.03.06 Project Management Applications
   2.03.07 Maintenance Analysis Software (RCM/FMECA)
   2.03.08 Performance Monitoring Applications
   2.03.09 Stores/Spares Optimisation Application
   2.03.10 EMS/LIMS—Environmental & Laboratory information systems
2.04 General Overall Information System Issues
   2.04.01 User Friendliness
   2.04.02 Integration of Systems
   2.04.03 Access/Response Issues
   2.04.04 System Strategy

### 3.00 Data and Knowledge (Data Availability/Quality)

3.01 Primary Data
   3.01.01 Asset Categories
   3.01.02 Hierarchical Structure and Level
   3.01.03 Location/Plans (Spatial Data)
   3.01.04 Primary Physical Asset Attributes
   3.01.05 Valuation Data
3.02 Secondary Data
   3.02.01 Full Detailed Attribute Data
   3.02.02 Condition Data
   3.02.03 Maintenance Data
   3.02.04 Operations/Failure Management Data
   3.02.05 Residual Life Data
   3.02.06 Works/Resource Management
3.03 Tertiary Data
   3.03.01 Risk Assessment & Management
   3.03.02 Cost Histories
   3.03.03 Intervention Options and Costs
   3.03.04 Optimised Renewal Decision Making (ORDM)
   3.03.05 Life Cycle Costs

### 4.00 Commercial Tactics (Contestability/Contracted Service Provision)

4.01 Core/Non Core Activities Identified
4.02 Packaging of Contracts
4.03 Specification Quality
4.04 Information and Data Availability
4.05 Contract Supervision (Performance Monitoring)
4.06 Contractor Assessment & Selection
4.07 Contract Support Systems

### 5.00 Organisational Issues

5.01 Sponsor, Structure and Policy
5.02 Life Cycle Asset Management Roles and Responsibilities
5.03 Asset Management Steering Committee (AMSC) Make-Up and Roles
5.04 Corporate Asset Management Team (AMT)
5.05 Business Asset Management Teams
5.06 Overall Commitment/Sustainability

### 6.00 People Issues

6.01 Skills and Age Profiles
6.02 Attitude and Culture
6.03 Change Management Activities
6.04 Appropriate Skills
6.05 Appropriate Resources
6.06 Training Programs
6.07 Corporate Knowledge Management
6.08 Appropriate Equipment and Support Systems

### 7.00 Total Asset Management Plans (Production Capability or Output Quality)

7.01 Current Standards
7.02 Knowledge of Assets
7.03 Projected Demands
7.04 Predicted Failure Modes
7.05 Consequences of Failure
7.06 Quality of Optimised Renewal Decision Making
7.07 Quality of New Works Programs
7.08 Quality of Operations and Maintenance Programs
7.09 Alternative Options Identified
7.10 Customer/Stakeholders Acceptance Surveys
7.11 Business Goals/TAMP Linkages

1. A knowledge management system for assisting asset owners, managers and operators in managing assets, the system including:
a database for storing a plurality of manuals, each manual including world's best practice guidelines with regard to an aspect of an asset life cycle;
a performance analysis tool for benchmarking an organisation's performance with regard to each aspect of the asset life cycle to identify areas for improvement; and
a benefit assessment component to assist the organisation in determining which improvements have potential to deliver the greatest benefits; wherein the knowledge management system enables the best practice guidelines to be tailored to suit particular organisations and/or asset types.

2. A system according to claim 1, wherein the performance analysis tool compares the organisation's performance with regard to each aspect of the asset life cycle to one or more of the following: world's best practice; practice being used by a set of similar organisations; or best appropriate practice for the organization concerned.

3. A system according to claim 1 further including: a goal setting component to enable the organisation to define one or more goals in accordance with the benefit assessment, the goals forming the basis of an asset management strategic plan; and a monitoring tool for monitoring the organisation's progress along the asset management strategic plan.

4. A system according to claim 3, further including a reporting component for generating reports which demonstrate improvements achieved relative to the goals set by the organisation.

5. A system according to claim 1, wherein the system is available to asset managers and operators over a telecommunications network.

6. A system according to claim 5, wherein the telecommunications network is the Internet.

7. A system according to claim 6, wherein the manuals are web-enabled.

8. A method for capturing, organising, storing and disseminating knowledge to assist asset owners, managers and operators in managing assets, the method including the following steps:
storing a plurality of manuals in a database, each manual including world's best practice guidelines with regard to an aspect of an asset life cycle;
benchmarking an organisation's performance with regard to each aspect of the asset life cycle to identify areas for improvement; and
assessing which improvements have potential to deliver the greatest benefits to the organisation; wherein the method enables the best practice guidelines to be tailored to each particular organisation and/or asset type.

9. A method according to claim 8, wherein the organisation's performance with regard to each aspect of the asset life cycle is benchmarked against one or more of the following:
world's best practice;
practice being used by a set of similar organisations; or
best appropriate practice.

10. A method according to claim 9, further including the following steps:
defining one or more goals in accordance with the benefit assessment, the goals forming the basis of an asset management strategic plan; and
monitoring the organisation's progress along the asset management strategic plan.

11. A method according to claim 10, further including the step of: generating reports which demonstrate improvements achieved relative to the goals set by the organisation.

12. A method for capturing, organising, storing and disseminating knowledge to assist asset owners, managers and operators in managing assets, the method including the following steps: storing a plurality of manuals in a database, each manual including best practice guidelines with regard to an aspect of an asset life cycle; benchmarking an organisation's performance with regard to each aspect of the asset life cycle to identify areas for improvement; and assessing which improvements have potential to deliver the greatest benefits to the organisation; determining a confidence level rating based on the quality of data used to benchmark the organisation's performance; providing a logical structure for the organisations to manage their assets through all aspects of the asset life cycle; defining one or more goals in accordance with the benefit assessment, the goals forming the basis of an asset management strategic plan; providing implementation guidelines to assist the organisation in achieving the goals; and monitoring the organisation's progress along the asset management strategic plan.

13-14. (canceled)
